(19) United States
(12) Patent Application Publication
(10) Pub. No.: US 2025/0119948 A1
(43) Pub. Date: Apr. 10, 2025

(54) MULTI-LINK RECONFIGURATION FOR WIRELESS SYSTEMS

(71) Applicant: Samsung Electronics Co., Ltd., Suwon-si (KR)

(72) Inventors: Rubayet Shafin, Frisco, TX (US); Boon Loong Ng, Plano, TX (US); Peshal Nayak, Plano, TX (US); Vishnu Vardhan Ratnam, Plano, TX (US)

(21) Appl. No.: 18/895,126

(22) Filed: Sep. 24, 2024

Related U.S. Application Data
(60) Provisional application No. 63/542,956, filed on Oct. 6, 2023.

(51) Int. Cl. H04W 74/0816; H04W 74/04; H04W 76/10

(52) U.S. Cl. CPC H04W 74/0816; H04W 74/04; H04W 76/10

(57) ABSTRACT

A non-access point multi-link device (non-AP MLD) in a wireless network, the non-AP MLD comprising a memory and a processor coupled to the memory, the processor is configured to establish a target-wake time (TWT) agreement or a TWT schedule on a first link between the non-AP MLD and an AP MLD, transmit a first frame to the AP MLD to reconfigure one or more links between the non-AP MLD and the AP MLD, wherein the first frame requests that the first link be deleted or disabled, receive a second frame from the AP MLD that indicates acceptance of the request to delete or disable the first link, and modify the TWT agreement or the TWT schedule on the first link.

### CROSS-REFERENCE TO RELATED APPLICATION(S)

This application claims the benefit of priority from U.S. Provisional Application No. 63/542,956, entitled “ML RECONFIGURATION PROCEDURES FOR NEXT GENERATION WLAN SYSTEMS” filed Oct. 6, 2023, which is incorporated herein by reference in its entirety.

### TECHNICAL FIELD

This disclosure relates generally to a wireless communication system, and more particularly to, for example, but not limited to, multi-link (ML) reconfiguration procedures for wireless systems.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a non-access point (AP) multi-link device (MLD) in a wireless network. The non-AP MLD comprises a memory and a processor coupled to the memory. The processor is configured to establish a target-wake time (TWT) agreement or a TWT schedule on a first link between the non-AP MLD and an AP MLD. The processor is configured to transmit a first frame to the AP MLD to reconfigure one or more links between the non-AP MLD and the AP MLD, wherein the first frame requests that the first link be deleted or disabled. The processor is configured to receive a second frame from the AP MLD that indicates acceptance of the request to delete or disable the first link. The processor is configured to modify the TWT agreement or the TWT schedule on the first link.

In some embodiments, the first frame requests that a second link be established between the non-AP MLD and the AP MLD.

In some embodiments, the processor is further configured to modify the TWT agreement or the TWT schedule by deleting the TWT agreement or the TWT schedule on the first link.

In some embodiments, the processor is further configured to modify the TWT agreement or the TWT schedule by suspending the TWT agreement or the TWT schedule on the first link.

In some embodiments, the processor is further configured to receive a third frame that recommends deleting or disabling the first link from the AP MLD, and transmit the first frame in response to the third frame.

In some embodiments, a dialog token of the first frame is set to a same value as a dialog token of the third frame.

In some embodiments the processor is further configured to receive a third frame that indicates the first link is to be deleted or disabled between the non-AP MLD and the AP MLD, and transmit the first frame in response to the third frame, wherein the first frame requests a second link be established between the non-AP MLD and the AP MLD before the first link is scheduled to be deleted or disabled.

In some embodiments, the first frame includes: a first profile element indicating that the first link is deleted or disabled, and a second profile element indicating that a second link is added.

In some embodiments, the first frame is transmitted on a second link between the non-AP MLD and the AP MLD.

One aspect of the present disclosure provides an access point (AP) multi-link device (MLD) in a wireless network. The AP MLD comprises a memory; and a processor coupled to the memory. The processor is configured to establish a target-wake time (TWT) agreement or a TWT schedule on a first link between the AP MLD and a non-AP MLD. The processor is configured to receive a first frame from the non-AP MLD to reconfigure one or more links between the AP MLD and the non-AP MLD, wherein the first frame requests that the first link be deleted or disabled. The processor is configured to transmit a second frame to the non-AP MLD that indicates acceptance of the request to delete or disable the first link. The processor is configured to modify the TWT agreement or the TWT schedule on the first link.

In some embodiments, the first frame requests that a second link be established between the AP MLD and the non-AP MLD.

In some embodiments, the processor is further configured to modify the TWT agreement or the TWT schedule by deleting the TWT agreement or the TWT schedule on the first link.

In some embodiments, the processor is further configured to modify the TWT agreement or the TWT schedule by suspending the TWT agreement or the TWT schedule on the first link.

In some embodiments, the processor is further configured to transmit a third frame to the non-AP MLD that recommends deleting or disabling the first link, and receive the first frame in response to the third frame.

In some embodiments, a dialog token of the first frame is a same value as a dialog token of the third frame.

In some embodiments, the processor is further configured to transmit a third frame that indicates the first link is to be deleted or disabled between the AP MLD and the non-AP MLD; and receive the first frame in response to the third frame, wherein the first frame requests a second link be established between the AP MLD and the non-AP MLD before the first link is scheduled to be deleted or disabled.

In some embodiments, the first frame includes a first profile element indicating that the first link is deleted or disabled, and a second profile element indicating that a second link is added.

In some embodiments, the first frame is received on a second link between the AP MLD and the non-AP MLD.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates multi-link discovery and setup in accordance with an embodiment.

FIG. 5A illustrates a basic multi-link element in accordance with an embodiment.

FIG. 5B illustrates a multi-link control field in accordance with an embodiment.

FIG. 5C illustrates a per-STA profile subelement format in accordance with an embodiment.

FIG. 5D illustrates a STA control field format in accordance with an embodiment of the invention.

FIG. 5E illustrates a STA info field format of a basic multi-link element in accordance with an embodiment.

FIG. 5F illustrates a presence bitmap subfield of a reconfiguration multi-link element in accordance with an embodiment.

FIG. 5G illustrates a common info field of a reconfiguration multi-link element in accordance with an embodiment.

FIG. 5H illustrates a per-STA profile subelement for a reconfiguration multi-link element in accordance with an embodiment.

FIG. 5I illustrates a STA control field format for a reconfiguration multi-link element in accordance with an embodiment.

FIG. 5J illustrates a STA info field format for a reconfiguration multi-link element in accordance with an embodiment.

FIG. 6 illustrates a frame exchange sequence for a delete and add operation for the same non-AP STA affiliated with a non-AP MLD in accordance with an embodiment.

FIG. 7 illustrates a AP MLD and a non-AP MLD configuration in accordance with an embodiment.

FIG. 8 illustrates a frame exchange on one link for delete/add operation for different links in accordance with an embodiment.

FIG. 9 illustrates a flow chart of an example process of link reconfiguration in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

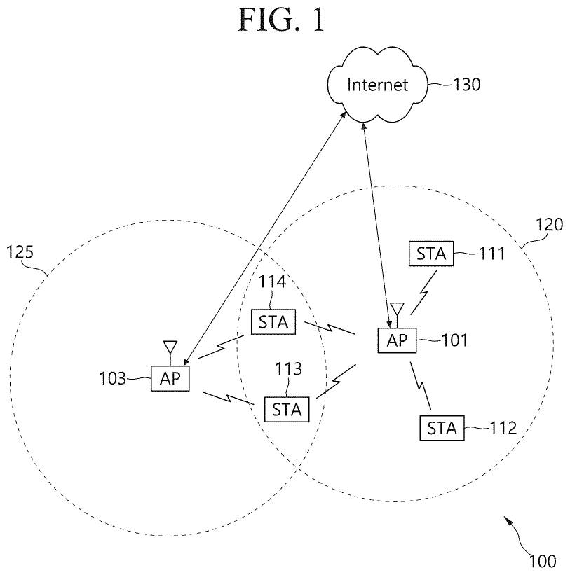

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage area 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs.

Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

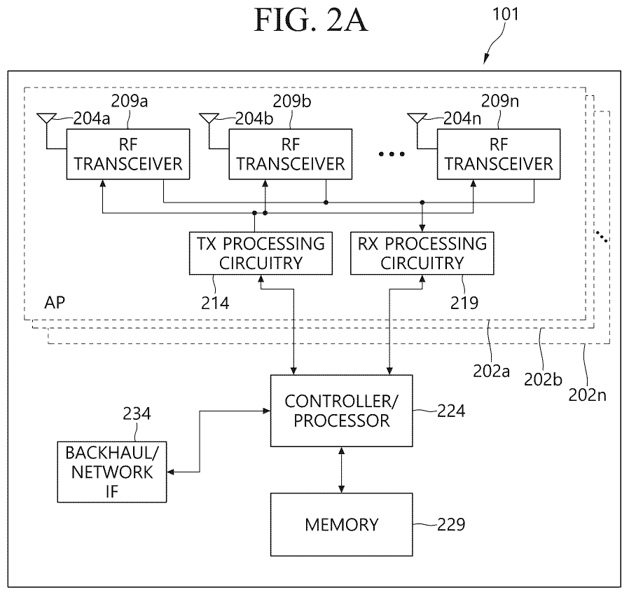

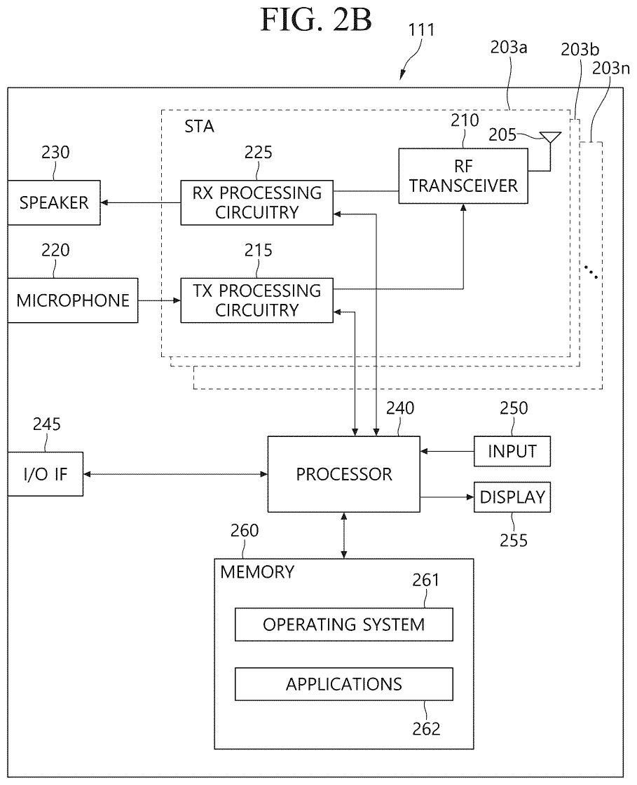

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

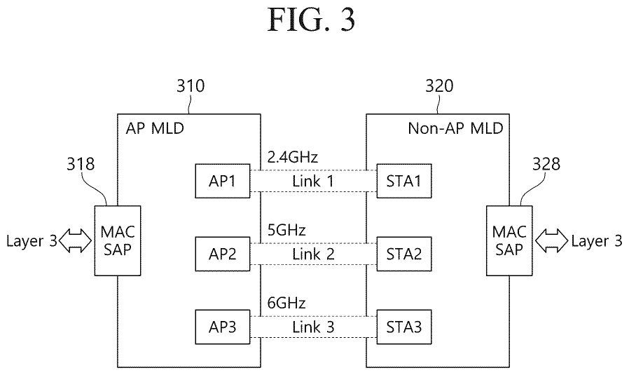

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D3.2, “Wireless LAN Medium Access Control (MAC) and Physical Layer (PHY) Specifications.”

Multi-link operation may allow the discovery and setup of multiple links between an AP MLD and a non-AP MLD, where the discovery or the setup can take place over a single link.

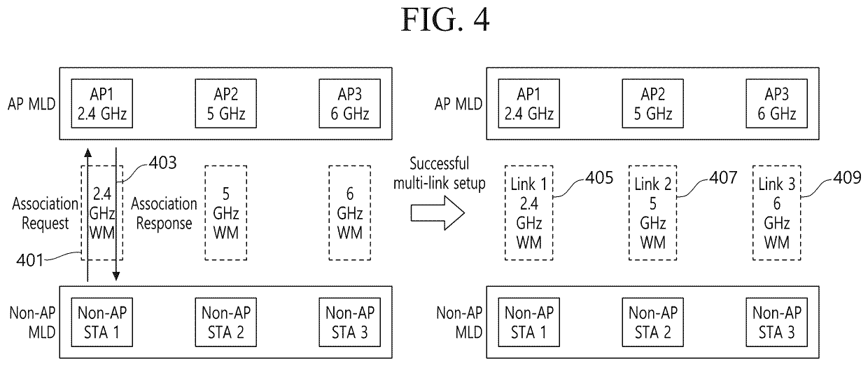

FIG. 4 illustrates multi-link discovery and setup in accordance with an embodiment. In particular, FIG. 4 illustrates an AP MLD communicating with a non-AP MLD. As illustrated, AP MLD is associated with AP1, AP2 and AP3, and non-AP MLD is associated with non-AP STA1, non-AP STA 2, and non-AP STA3. The non-AP MLD transmits an association request frame 401 to AP MLD. AP MLD then transmits an association response frame 403 to non-AP MLD. In FIG. 4, the association request frame 401 and the association response frame takes place over the 2.4 GHz link between the an AP MLD and a non-AP MLD, where the setup is for establishing three links between the AP MLD and the non-AP MLD: one link on the 2.4 GHz band, a second link on the 5 GHz band, and a third link on the 6 GHz band. After the successful setup, the three links, including link 1 at 2.5 GHz 405, link 2 at 5 GHz 407, and link 3 at 6 GHz 409, are established between the AP MLD and the non-AP MLD.

In some embodiments, using the ML reconfiguration, an AP MLD can add or remove one or more links or a non-AP MLD may request to add or remove one or more links. In some embodiments, using an advertised traffic identifier (TID)-to-Link mapping, an AP can disable a link for all the non-AP MLDs associated with the AP MLD.

In some embodiments, for the scenario where a non-AP MLD intends to establish a new link with its associated AP MLD, the non-AP MLD can send a link reconfiguration request frame to the AP MLD. The link reconfiguration request frame can include a basic multi-link element to indicate the link that the non-AP MLD intends to add. The basic multi-link element included in the link reconfiguration request frame may also include information pertaining to the link(s) that is/are requested to be added. The basic multi-Link element included in the link reconfiguration request frame may also include information pertaining to links that may or may not be links that are requested to be added.

In some embodiments, a possible format of a link reconfiguration request frame is shown in Table 1.

TABLE 1

| Order | Meaning |
|---|---|
| 1 | Category |
| 2 | Protected EHT Action |
| 3 | Dialog Token |
| 4 | Reconfiguration Multi-Link element |
| 5 | OCI element |
| 6 | Basic Multi-Link element |

The category field may provide category information for the request frame. The protected extremely high throughput (EHT) action field may indicate ML reconfiguration information. The reconfiguration multi-link element may provide reconfiguration information. The operating channel information (OCI) element may provide operating channel information. The basic multi-link element may provide multi-link information.

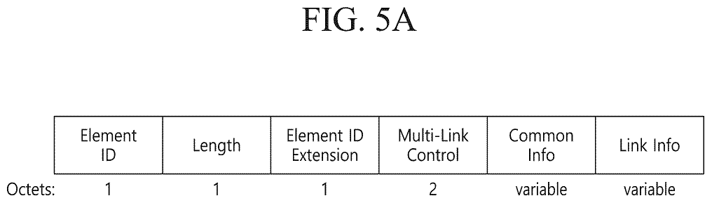

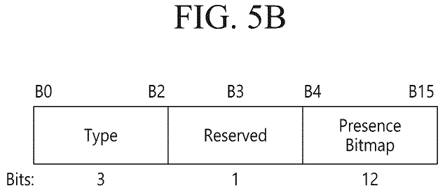

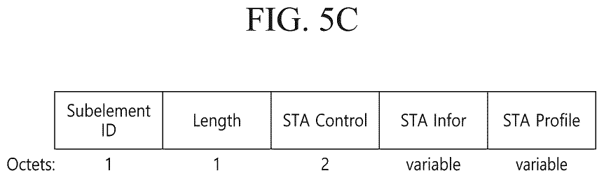

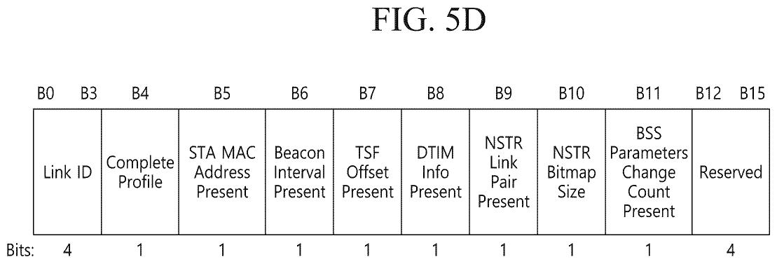

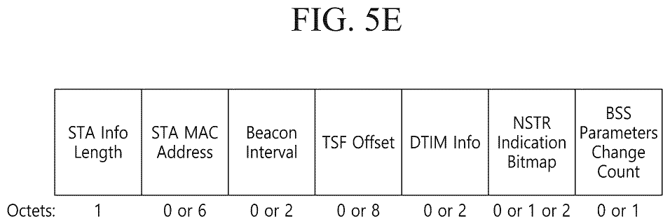

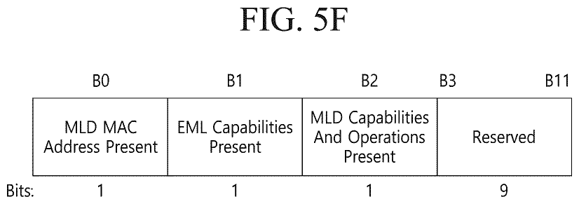

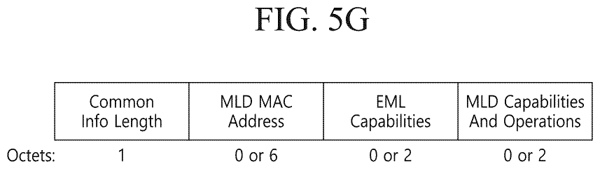

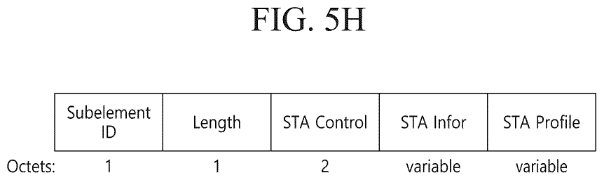

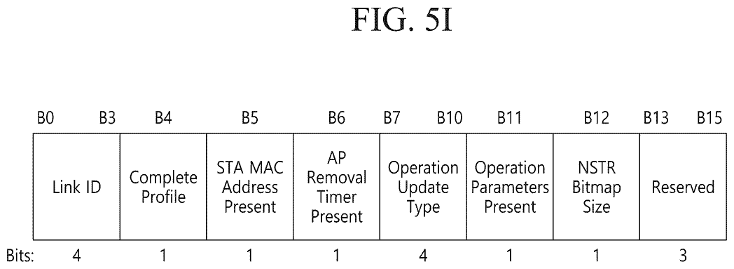

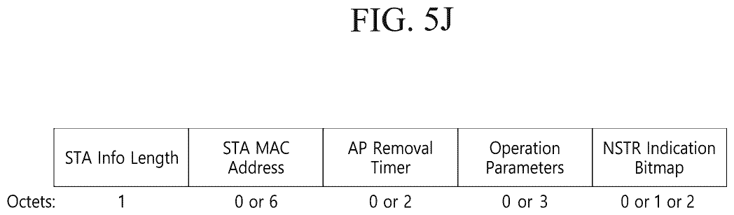

FIGS. 5A, 5B, 5C, 5D, 5E, 5F and 5G illustrate a format and various subfields of a basic multi-link element in accordance with an embodiment.

FIG. 5A illustrates a basic multi-link element in accordance with an embodiment. The multi-link element may include an element ID field, a length field, an element ID extension field, a multi-link control field, a common info field, and a link info field. The element ID field may provide an identifier for the element. The length field may provide length information for the element. The element ID extension field may provide extension information for the element. The multi-link control field may include link control information and can include several subfields as illustrated in FIG. 5B. The common info field can include information that is common to one or more links. The link info field can provide link information specific to one or more links, and may include one or more per-STA profile subelements, as illustrated in FIG. 5C.

FIG. 5B illustrates a multi-link control field in accordance with an embodiment. The multi-link control field can include a type field, a reserved field, and a presence bitmap field. The type field can be used to differentiate the variants of the multi-link element including, for example and without limitation, a basic Multi-link element, a Probe Request Multi-Link element, a Reconfiguration Multi-link element, a TDLS Multi-Linik element and a EPCS Priority Access Multi-Link element. The reserved field may be reserved. The presence bitmap field may be used to indicate the presence of various subfields in the common info field and the subfield may have a different format for the different variants of the multi-link element.

FIG. 5C illustrates a per-STA profile subelement format in accordance with an embodiment. The per-STA profile subelement can include a subelement ID field, a length field, a STA control field, a STA info field, and a STA profile field. The subelement ID field can provide an identifier for the element. The length field can provide length information for the element. The STA control field provide control information for the element, and can include various subfields as illustrated in FIG. 5D in accordance with an embodiment. The STA info field can provide STA information for the element. The STA profile field can provide STA profile information for the element.

FIG. 5D illustrates a STA control field format in accordance with an embodiment of the invention. The STA control field format may include a link ID field, a complete profile field, a STA MAC Address present field, a beacon interval present field, a timing synchronization function (TSF) offset present field, a delivery traffic indication message (DTIM) Info present field, a nonsimultaneous transmit and receive (NSTR) link pair present field, a NSTR bitmap size field, a basic service set (BSS) parameters change count present field, and a reserved field.

The link ID field may specify a value that uniquely identifies the link where the reported STA is operating on. The complete profile field may be set to 1 when the per-STA profile subelement of the multi-link element carries a complete profile, otherwise, the subfield may be set to 0. The STA MAC address present subfield may indicate the presence of the STA MAC address subfield in the STA info field. The beacon interval present subfield may indicate the presence of the beacon intervale subfield in the STA info field. The TSF offset present subfield may indicate the presence of the TSF offset present subfield in the STA info field. The DTIM info present subfield may indicate the presence of the DTIM info subfield in the STA info field. The NSTR link pair present subfield may indicate the presence of the NSTR link pair present subfield in the STA info field.

The NSTR Bitmap size field provides size information for the NSTR bitmap. The BSS parameters change count present field indicates the presence of the BSS parameters change count subfield in the STA info field. The reserved field may be reserved.

FIG. 5E illustrates a STA info field format of a basic multi-link element in accordance with an embodiment. The STA info field may include a STA info length field, a STA MAC address field, a beacon interval field, a TSF offset field, a DTIM info field, a NSTR indication bitmap field, and a BSS parameters change count field. The STA info length field may provide length information for the STA info field. The STA MAC address field may carry the MAC address of the STA that operates on the link identified by the link ID subfield and is affiliated with the same MLD as the STA that transmits the basic multi-link element. The beacon interval field may carry the beacon interval for the reported AP. The TSF offset field may indicate the offset between the TSF time of the reported AP and the TSF timer of the reporting AP. The DTIM info field may provide DTIM information. The NSTR indication bitmap provides NSTR indication information. The BSS parameters change count field may carry the most recent BSS parameters change count corresponding to the reported AP.

FIG. 5F illustrates a presence bitmap subfield of a reconfiguration multi-link element in accordance with an embodiment. The presence bitmap subfield of the reconfiguration multi-link element may include a MLD MAC address present field, a EML capabilities present field, a MLD capabilities and operations present field, and a reserved field. The MLD MAC address present subfield indicates the presence of the MLD MAC address field in the common info field. The EML capabilities present field may indicate the presence of the EML capabilities subfield in the common info field. The MLD capabilities and operations present field may indicate the presence of the MLD capabilities and operations subfield in the common info field. The reserved field may be reserved.

FIG. 5G illustrates a common info field of a reconfiguration multi-link element in accordance with an embodiment. The common info field may include a common info length field, a MLD MAC address field, a EML capabilities field, and a MLD capabilities and operations field. The common info length field may provide length information for the common info field. The MLD MAC address field may specify the MAC address of the MLD described by the reconfiguration multi-link element. The EML capabilities field may provide EML capabilities information. The MLD capabilities and operations field may provide MLD capabilities and operation information.

FIG. 5H illustrates a per-STA profile subelement for a reconfiguration multi-link element in accordance with an embodiment. The per-STA profile may include a subelement ID field, a length field, a STA control field, a STA info field, and a STA profile field. The subelement ID field may provide an identifier for the subelement. The length field may provide length information for the element. The STA control field may provide control information, and may include several subfields as illustrated by FIG. 5I. The STA info field may provide STA information and may include several subfields as illustrated by FIG. 5J. The STA profile field may provide profile information.

FIG. 5I illustrates a STA control field format for a reconfiguration multi-link element in accordance with an embodiment. The STA control field may include a link ID field, a complete profile field, a STA MAC address present field, a AP removal timer present field, an operation update type field, an operation parameters present field, a NSTR bitmap size field, and a reserved field. The link ID field may specify a value that uniquely identifies the link that the reported AP is operating on. In a reconfiguration multi-link element transmitted by a non-AP MLD, the link ID field may specify the link for which a reconfiguration operation is indicated. The complete profile field provides profile information. The STA MAC address present field may indicate the presence of the STA MAC address subfield in the STA info field. The AP removal timer present field may indicate the presence of the AP removal timer subfield in the STA info field. The operation update type field may indicate the type of MLO update for the link indicated by the link ID field including, for example and without limitation, AP Removal, Operation Parameter Update, Add Link, and Delete Link. The operation parameters present field may indicate the presence of the operation parameters field in the STA info field. The NSTR bitmap size may provide size information for the NSTR indication bitmap subfield in the STA info field. The reserved field may be reserved.

FIG. 5J illustrates a STA info field format for a reconfiguration multi-link element in accordance with an embodiment. The STA info field format may include a STA info length field, a STA MAC address field, a AP removal timer field, an operation parameters field, and a NSTR indication bitmap field. The STA info length field may provide length information for the STA info field. The STA MAC address field may carry the MAC address for the STA that operations or can operate on the link identified by the link ID field and is affiliated with the same MLD as the STA that transmitted the reconfiguration multi-link element. The AP removal timer field may indicate the number of TBTTs of the AP corresponding to the per-STA profile subelement until the AP is removed. The operation parameters field may provide operation information and may include various subfields. The NSTR indication bitmap field may indicate the NSTR link pairs for the non-AP MLD. The NSTR indication bitmap field may not be included in the reconfiguration multi-link element transmitted by an AP MLD.

In some embodiments, if the basic multi-link element is present in the link reconfiguration request frame, then the reconfiguration multi-link element may not be present in the link reconfiguration request frame. In some embodiments, a possible format of a link reconfiguration request frame action field format is shown in Table 2.

TABLE 2

| Order | Meaning |
|---|---|
| 1 | Category |
| 2 | Protected EHT Action |
| 3 | Dialog Token |
| 4 | OCI element |
| 5 | Basic Multi-Link element |

The category field may provide category information for the request frame. The protected extremely high throughput (EHT) action field may indicate ML reconfiguration information. The dialog token may provide token information for the request frame. The operating channel information (OCI) element may provide operating channel information. The basis multi-link element may provide multi-link information.

In some embodiments, the order of the basic multi-link element in the link reconfiguration request can be different than the one shown in Table 2 or Table 1. For example, the order of the basic Multi-link element in the link reconfiguration request frame can be 4 as shown in Table 3.

TABLE 3

| Order | Meaning |
|---|---|
| 1 | Category |
| 2 | Protected EHT Action |
| 3 | Dialog Token |
| 4 | Basic Multi-Link element |
| 5 | OCI element |

The category field may provide category information for the frame. The protected extremely high throughput (EHT) action field may indicate ML reconfiguration information. The dialog token may provide token information for the frame. The basic multi-link element may provide multi-link information. The operating channel information (OCI) element may provide operating channel information.

Some embodiments may include procedures for a TWT agreement teardown. In some embodiments, a non-AP MLD may be associated with an AP MLD and a first TWT agreement or TWT schedule is established on a first link between the AP MLD and the non-AP MLD. In some embodiments, if the first link is deleted using an ML reconfiguration procedure, then the information related to the first TWT agreement or TWT schedule may also be deleted (e.g., the first TWT agreement or TWT schedule can be assumed to be torn down).

In certain embodiments, a non-AP MLD may be associated with an AP MLD and a first TWT agreement or TWT schedule may be established on a first link between the AP MLD and the non-AP MLD. In certain embodiments, if the first link is deleted using an ML Reconfiguration procedure, then the information related to the first TWT agreement or TWT schedule is not deleted (e.g., the first TWT agreement or TWT schedule can be assumed to be suspended).

In some embodiments, a non-AP MLD may be associated with an AP MLD and a first TWT agreement or TWT schedule is established on a first link between the AP MLD and the non-AP MLD. In some embodiments, if the first link is disabled using a TID-To-Link mapping procedure, then the information related to the first TWT agreement or TWT schedule may also be deleted (e.g., the first TWT agreement or TWT schedule can be assumed to be torn down).

In some embodiments, a non-AP MLD may be associated with an AP MLD and a first TWT agreement or TWT schedule may be established on a first link between the AP MLD and the non-AP MLD, In certain embodiments, if the first link is disabled using a TID-To-Link mapping procedure, then the information related to the first TWT agreement or TWT schedule is not deleted (e.g., the first TWT agreement or TWT schedule can be assumed to be suspended). When the link is enabled again, the TWT agreement or TWT schedule may be re-instantiated or resumed.

Described hereinafter are dialog tokens, as described by e.g., tables 1, 2 or 3, of link reconfiguration request frames in accordance with several embodiments. In some embodiments, a non-AP MLD may receive a link reconfiguration recommendation from its associated AP MLD by receiving a link reconfiguration notify frame from the AP MLD. In some embodiments, if the non-AP MLD subsequently transmits a link recommendation request frame to the AP MLD as a response to receiving the link reconfiguration notify frame, then the non-AP MLD, in the link recommendation request frame transmitted to the AP MLD, can set the dialog token field to the same value as indicated in the dialog token field of the link recommendation notify frame received from the AP MLD. The dialog token of the link recommendation request frame having the same value as the dialog token on the link recommendation notify frame may indicate that the request frame is of the same sequence (e.g., a sequence having notify/request/response frames) of the link recommendation request frame.

In some embodiments, a non-AP MLD may be associated with an AP MLD, and a single link, referred to as a first link, may be established between the AP MLD and the non-AP MLD. In some embodiments, if the AP MLD announces that the first link is impending to be deleted (e.g., using an ML reconfiguration procedure), then the non-AP MLD can send a link reconfiguration request frame to the AP MLD in order to indicate its request to establish a second link between the AP MLD and the non-AP MLD. The non-AP MLD may send the request to the AP MLD (e.g., by sending the link reconfiguration request frame to the AP MLD) to establish the second link between the AP MLD and the non-AP MLD before the first link is scheduled to be deleted. This way the non-AP MLD can avoid getting disassociated from the AP MLD.

In some embodiments, a first link may be established between a first AP affiliated with an AP MLD and a first non-AP STA affiliated with a non-AP MLD associated with the AP MLD. The non-AP MLD may send a request to the AP MLD to delete the first link between the first AP and the first non-AP STA, and may request the AP MLD to establish a second link between the first non-AP STA and a second AP affiliated with the same AP MLD.

In some embodiments, a first link may be established between a first AP affiliated with an AP MLD and a first non-AP STA affiliated with a non-AP MLD associated with the AP MLD. In some embodiments, if the non-AP MLD intends to request the AP MLD to delete the first link between the first AP and the first non-AP STA, and request the AP MLD to establish a second link between the first non-AP STA and a second AP affiliated with the same AP MLD, then the non-AP MLD can send a link reconfiguration request frame to the AP MLD through an enabled link between the AP MLD and the non-AP MLD. In some embodiments, an enabled link may be a setup link between an AP MLD and a non-AP MLD to which at least one traffic identifier (TID) is mapped either in downlink or in uplink. In some embodiments, the link reconfiguration request frame may include a reconfiguration multi-link element that can include one or more per-STA profile subelements (e.g., two Per-STA profile subelements). In some embodiments, the first Per-STA profile sub-element may indicate that it is for deleting an existing link (e.g., the first link) by setting the reconfiguration operation type subfield value to 3 (Delete Link). The link ID subfield of the first Per-STA profile sub-element can be set to the link ID value corresponding to the first AP. The STA MAC address of the first Per-STA profile sub-element can be set to the STA MAC address value of the first non-AP STA. The second Per-STA profile sub-element may indicate that it is for adding a new link (e.g., the second link) by setting the reconfiguration operation type subfield value to 2 (Add Link). The link ID subfield of the second Per-STA profile sub-element can be set to the link ID value corresponding to the second AP affiliated with the AP MLD. The STA MAC address of the second Per-STA profile sub-element can be set to the STA MAC address value of the first non-AP STA. The non-AP MLD can send the link reconfiguration request frame to the AP MLD over the same link as the link that is being requested to be deleted or can send the link reconfiguration request frame over a different link than the link that is being requested to be deleted.

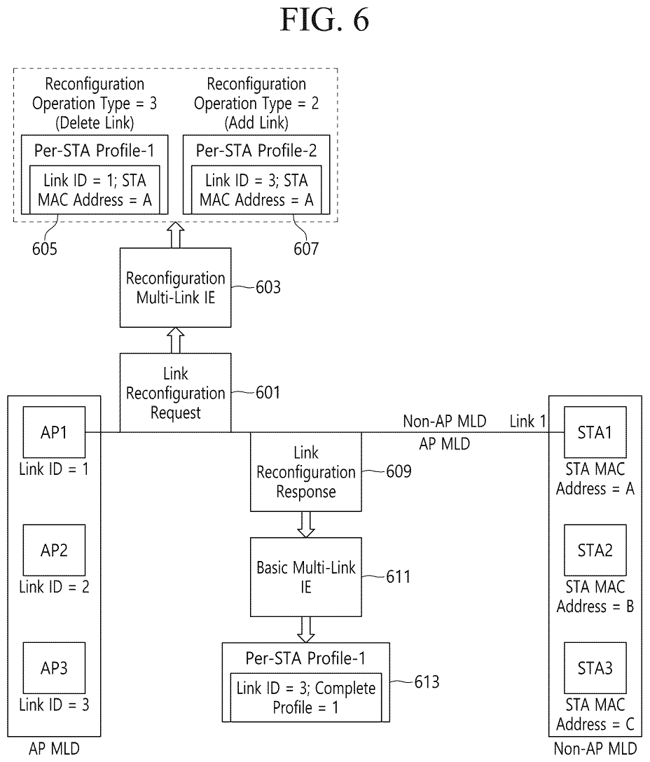

FIG. 6 illustrates a frame exchange sequence for a delete and add operation for the same non-AP STA affiliated with a non-AP MLD in accordance with an embodiment. As illustrates AP MLD is associated with non-AP MLD. AP MLD includes three affiliated APs (e.g., AP1, AP2, and AP3). Non-AP MLD includes three affiliated STAs (e.g., STA1, STA2, and STA3). Non-AP MLD transmits to AP MLD a link reconfiguration request frame 601, that may include a reconfiguration multi-link information element 603 that can include two Per-STA profile sub-elements 605 and 607. In some embodiments, the first Per-STA profile sub-element 605 may indicate that it is for deleting an existing link (e.g., the first link) by setting the reconfiguration operation type subfield value to 3 (Delete Link). The link ID subfield of the first Per-STA profile sub-element 605 can be set to the link ID value corresponding to the first AP, AP1 (i.e., Link ID=1). The STA MAC address of the first Per-STA profile sub-element 605 can be set to the STA MAC address value of the first non-AP STA, STA1 (i.e., STA MAC address=A). The second Per-STA profile sub-element 607 may indicate that it is for adding a new link (i.e., link 3) by setting the reconfiguration operation type subfield value to 2 (Add Link). The link ID subfield of the second Per-STA profile sub-element 607 can be set to the link ID value corresponding to the AP3 affiliated with the AP MLD (i.e., Link ID=3). The STA MAC address of the second Per-STA profile sub-element 607 can be set to the STA MAC address value of the first non-AP STA, STA1 (i.e., STA MAC address=A). As illustrated, the non-AP MLD can send the link reconfiguration request frame 601 to the AP MLD over the same link as the link that is being requested to be deleted (e.g., link 1). In some embodiments, the non-AP MLD can send the link reconfiguration request frame 601 over a different link than the link that is being requested to be deleted. The AP MLD may transmit a link reconfiguration response frame 609 to the non-AP MLD. The link reconfiguration response frame 609 may include a basic multi-link information element 611, which may include a per-STA profile 613, that sets link ID=3 and complete profile=1.

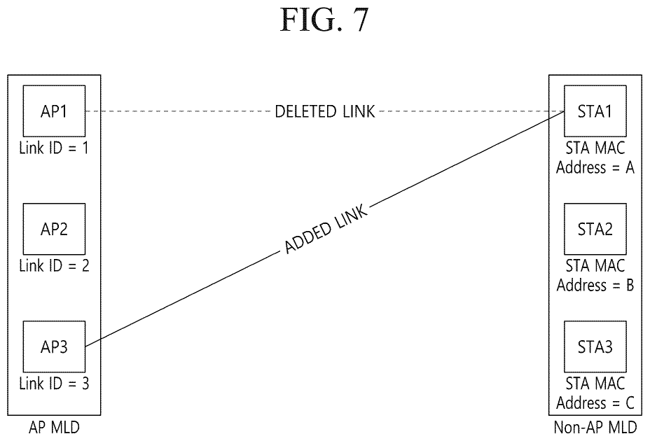

In some embodiments, after the successful frame exchanges as shown in FIG. 6, the existing link between STA1 and AP1 is deleted and a new link between STA1 and AP3 is established as illustrated in FIG. 7 in accordance with an embodiment. In particular, FIG. 7 illustrates the AP MLD and a non-AP MLD configuration of FIG. 6. AP MLD includes three affiliated APs (e.g., AP1, AP2 and AP3) and non-AP MLD includes three affiliated STAs (e.g., STA1, STA2, and STA3). As illustrated, the link ID 1 between AP1 and STA1 has been deleted, and a new link with link ID 3 has been established between AP3 and STA1.

In some embodiments, a first link is established between a first AP affiliated with an AP MLD and a first non-AP STA affiliated with a non-AP MLD associated with the AP MLD. If the non-AP MLD intends to request the AP MLD to delete the first link between the first AP and the first non-AP STA, and request the AP MLD to establish a second link between the first non-AP STA and a second AP affiliated with the same AP MLD, then the non-AP MLD can send the corresponding link reconfiguration request frame on a different existing link (e.g., a third link) between the AP MLD and the non-AP MLD.

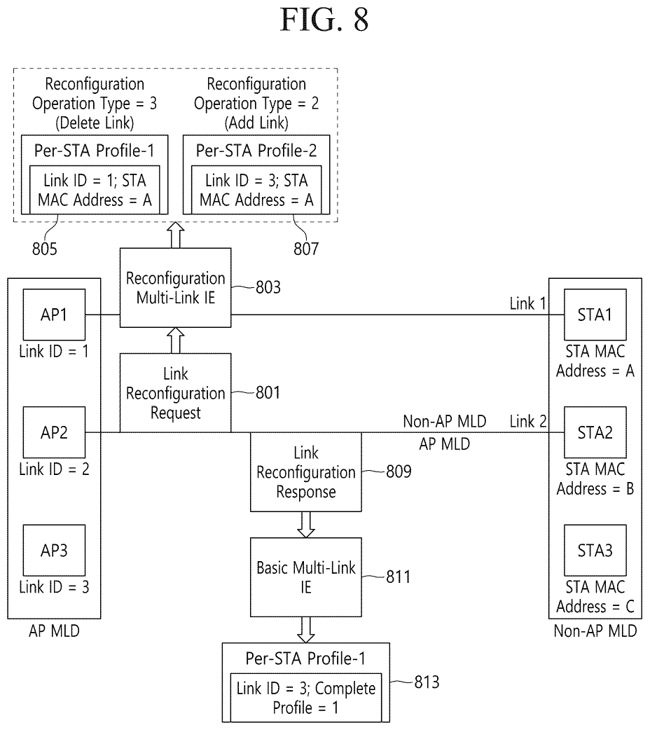

FIG. 8 illustrates a frame exchange on one link for delete/add operation for different links in accordance with an embodiment. As illustrated, AP MLD includes three affiliated APs (e.g., AP1, AP2, and AP3) and non-AP MLD include three affiliated STAs (e.g., STA1, STA2, and STA3). In the example of FIG. 8, link 1 is being deleted based on frame exchange on link 2. In particular, non-AP MLD transmits a link reconfiguration request 801 from STA2 on link 2 to AP2 affiliated with AP MLD. The link reconfiguration request frame 801 includes a reconfiguration multi-link information element 803 that includes a per-STA profile 1 805 and per-STA profile 2 807. The per-STA profile sub-element 805 may indicate that it is for deleting an existing link (e.g., the first link) by setting the reconfiguration operation type subfield value to 3 (Delete Link). The link ID subfield of the first Per-STA profile sub-element 805 can be set to the link ID value corresponding to the first AP, AP1 (i.e., Link ID=1). The STA MAC address of the first Per-STA profile sub-element 805 can be set to the STA MAC address value of the first non-AP STA, STA1 (i.e., STA MAC address=A). The second Per-STA profile sub-element 807 may indicate that it is for adding a new link (i.e., link 3) by setting the reconfiguration operation type subfield value to 2 (Add Link). The link ID subfield of the second Per-STA profile sub-element 807 can be set to the link ID value corresponding to the AP3 affiliated with the AP MLD (i.e., Link ID=3). The STA MAC address of the second Per-STA profile sub-element 807 can be set to the STA MAC address value of the first non-AP STA, STA1 (i.e., STA MAC address=A).

As illustrated, the non-AP MLD can send the link reconfiguration request frame 801 to the AP MLD over a different link, link 2, as the link that is being requested to be deleted (e.g., link 1). AP2 affiliated with the AP MLD may transmit a link reconfiguration response frame 809 to STA2. The link reconfiguration response frame 809 may include a basic multi-link information element 811, which may include a per-STA profile 813, that sets link ID=3 and complete profile=1.

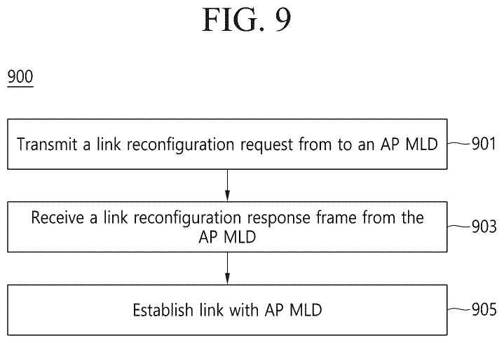

FIG. 9 illustrates a flow chart of an example process of reconfiguring a link in accordance with an embodiment. Although one or more operations are described or shown in particular sequential order, in other embodiments the operations may be rearranged in a different order, which may include performance of multiple operations in at least partially overlapping time periods. The flowchart depicted in FIG. 9 illustrates operations performed in an a non-AP MLD, such as non-AP MLD illustrated in FIG. 3.

The process 900, in operation 901, by a non-AP MLD, transmits a link reconfiguration request frame to the AP MLD. In some embodiments, the link reconfiguration request frame can include a basic Multi-link element to indicate the link that the non-AP MLD intends to add and/or delete or suspend. The basic Multi-link element may also include information pertaining to links that may or may not be links that are requested to be added and/or deleted. In some embodiments, if a link is to be deleted, then information related to a TWT agreement or a TWT schedule on the link may also be deleted or disabled. In certain embodiments, if a link is to be suspended, then information related to a TWT agreement or a TWT schedule on the link is not deleted (i.e., the TWT agreement or TWT schedule can be assumed to be suspended). In some embodiments, if an AP MLD announces that a first link is impending to be deleted, then the non-AP MLD can send the link reconfiguration request frame to the AP MLD in order to indicate its request to establish a second link between the AP MLD and the non-AP MLD, where the second link is requested to be established before the first link is scheduled to be deleted, which can avoid the non-AP MLD being disassociated from the AP MLD. In some embodiments, for the scenario where a first link is established between a first AP affiliated with an AP MLD and a first non-AP STA affiliated with the non-AP MLD associated with the AP MLD, if the non-AP MLD intends to request the AP MLD to delete the first link between the first AP and the first non-AP STA, and request the AP MLD to establish a second link between the first non-AP STA and a second AP affiliated with the same AP MLD, then the non-AP MLD can send the corresponding Link Reconfiguration Request frame on a different existing link (say, a third link) between the AP MLD and the non-AP MLD

In operation 903, the non-AP MLD receives a link reconfiguration response frame from the AP MLD. In some embodiments, the link reconfiguration response frame may include a basic multi-link information element that can include a Per-STA profile element to indicate the status of the reconfiguration (i.e., complete or request denied, among other statuses).

In operation 905, the non-AP MLD establishes a link with the AP MLD. In some embodiments a link may be established between a first STA affiliated with the non-AP MLD and a first AP affiliated with the AP MLD. The first STA and the first AP may communicate, including transmitting and receiving data, using the link through which the first STA is associated with the first AP.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As described herein, any electronic device and/or portion thereof according to any example embodiment may include, be included in, and/or be implemented by one or more processors and/or a combination of processors. A processor is circuitry performing processing.

Processors can include processing circuitry, the processing circuitry may more particularly include, but is not limited to, a Central Processing Unit (CPU), an MPU, a System on Chip (SoC), an Integrated Circuit (IC) an Arithmetic Logic Unit (ALU), a Graphics Processing Unit (GPU), an Application Processor (AP), a Digital Signal Processor (DSP), a microcomputer, a Field Programmable Gate Array (FPGA) and programmable logic unit, a microprocessor, an Application Specific Integrated Circuit (ASIC), a neural Network Processing Unit (NPU), an Electronic Control Unit (ECU), an Image Signal Processor (ISP), and the like. In some example embodiments, the processing circuitry may include: a non-transitory computer readable storage device (e.g., memory) storing a program of instructions, such as a DRAM device; and a processor (e.g., a CPU) configured to execute a program of instructions to implement functions and/or methods performed by all or some of any apparatus, system, module, unit, controller, circuit, architecture, and/or portions thereof according to any example embodiment and/or any portion of any example embodiment. Instructions can be stored in a memory and/or divided among multiple memories.

Different processors can perform different functions and/or portions of functions. For example, a processor 1 can perform functions A and B and a processor 2 can perform a function C, or a processor 1 can perform part of a function A while a processor 2 can perform a remainder of function A, and perform functions B and C. Different processors can be dynamically configured to perform different processes. For example, at a first time, a processor 1 can perform a function A and at a second time, a processor 2 can perform the function A. Processors can be located on different processing circuitry (e.g., client-side processors and server-side processors, device-side processors and cloud-computing processors, among others).

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A non-access point (AP) multi-link device (MLD) in a wireless network, the non-AP MLD comprising:
a memory; and
a processor coupled to the memory, the processor configured to:
establish a target-wake time (TWT) agreement or a TWT schedule on a first link between the non-AP MLD and an AP MLD;
transmit a first frame to the AP MLD to reconfigure one or more links between the non-AP MLD and the AP MLD, wherein the first frame requests that the first link be deleted or disabled;
receive a second frame from the AP MLD that indicates acceptance of the request to delete or disable the first link; and
modify the TWT agreement or the TWT schedule on the first link.

2. The non-AP MLD of claim 1, wherein the first frame requests that a second link be established between the non-AP MLD and the AP MLD.

3. The non-AP MLD of claim 1, wherein the processor is further configured to modify the TWT agreement or the TWT schedule by deleting the TWT agreement or the TWT schedule on the first link.

4. The non-AP MLD of claim 1, wherein the processor is further configured to modify the TWT agreement or the TWT schedule by suspending the TWT agreement or the TWT schedule on the first link.

5. The non-AP MLD of claim 1, wherein the processor is further configured to:
receive a third frame that recommends deleting or disabling the first link from the AP MLD; and
transmit the first frame in response to the third frame.

6. The non-AP MLD of claim 5, wherein a dialog token of the first frame is set to a same value as a dialog token of the third frame.

7. The non-AP MLD of claim 1, wherein the processor is further configured to:
receive a third frame that indicates the first link is to be deleted or disabled between the non-AP MLD and the AP MLD; and
transmit the first frame in response to the third frame, wherein the first frame requests a second link be established between the non-AP MLD and the AP MLD before the first link is scheduled to be deleted or disabled.

8. The non-AP MLD of claim 1, wherein the first frame includes:
a first profile element indicating that the first link is deleted or disabled; and
a second profile element indicating that a second link is added.

9. The non-AP MLD of claim 1, wherein the first frame is transmitted on a second link between the non-AP MLD and the AP MLD.

10. An access point (AP) multi-link device (MLD) in a wireless network, the AP MLD comprising:
a memory; and
a processor coupled to the memory, the processor configured to:
establish a target-wake time (TWT) agreement or a TWT schedule on a first link between the AP MLD and a non-AP MLD;
receive a first frame from the non-AP MLD to reconfigure one or more links between the AP MLD and the non-AP MLD, wherein the first frame requests that the first link be deleted or disabled;
transmit a second frame to the non-AP MLD that indicates acceptance of the request to delete or disable the first link; and
modify the TWT agreement or the TWT schedule on the first link.

11. The AP MLD of claim 10, wherein the first frame requests that a second link be established between the AP MLD and the non-AP MLD.

12. The AP MLD of claim 10, wherein the processor is further configured to modify the TWT agreement or the TWT schedule by deleting the TWT agreement or the TWT schedule on the first link.

13. The AP MLD of claim 10, wherein the processor is further configured to modify the TWT agreement or the TWT schedule by suspending the TWT agreement or the TWT schedule on the first link.

14. The AP MLD of claim 10, wherein the processor is further configured to:
transmit a third frame to the non-AP MLD that recommends deleting or disabling the first link; and
receive the first frame in response to the third frame.

15. The AP MLD of claim 14, wherein a dialog token of the first frame is a same value as a dialog token of the third frame.

16. The AP MLD of claim 10, wherein the processor is further configured to:
transmit a third frame that indicates the first link is to be deleted or disabled between the AP MLD and the non-AP MLD; and
receive the first frame in response to the third frame, wherein the first frame requests a second link be established between the AP MLD and the non-AP MLD before the first link is scheduled to be deleted or disabled.

17. The AP MLD of claim 10, wherein the first frame includes:
a first profile element indicating that the first link is deleted or disabled; and
a second profile element indicating that a second link is added.

18. The AP MLD of claim 10, wherein the first frame is received on a second link between the AP MLD and the non-AP MLD.

19. A computer-implemented method for reconfiguring a non-access point (AP) multi-link device (MLD) in a wireless network, the method comprising:
establishing, by the non-AP MLD, a target-wake time (TWT) agreement or a TWT schedule on a first link between the non-AP MLD and an AP MLD;
transmitting a first frame to the AP MLD to reconfigure one or more links between the non-AP MLD and the AP MLD, wherein the first frame requests that the first link be deleted or disabled;
receiving a second frame from the AP MLD that indicates acceptance of the request to delete or disable the first link; and
modifying the TWT agreement or the TWT schedule on the first link.

20. The computer-implemented method of claim 19, wherein the first frame requests that a second link be established between the non-AP MLD and the AP MLD.
